(19) United States
(12) Patent Application Publication
(10) Pub. No.: US 2015/0115603 A1
(43) Pub. Date: Apr. 30, 2015

(54) SEAL FITTING WITH O-RING

(71) Applicant: Ford Global Technologies, LLC, Dearborn, MI (US)

(72) Inventors: Gregory C. Trombley, Grosse Ile, MI (US); Manfred Koberstein, Troy, MI (US); Steven L. Lambert, Washington, MI (US)

(73) Assignee: Ford Global Technologies, LLC, Dearborn, MI (US)

(21) Appl. No.: 14/066,977

(22) Filed: Oct. 30, 2013

(51) Int. Cl. F16L 19/02; F16L 23/02; F16L 23/18

(52) U.S. Cl. CPC F16L 19/0218; F16L 23/18; F16L 23/02
USPC 285/368; 285/363

(57) ABSTRACT

A sealing system, comprises a male block including an annular flange, a female block including an annular recess configured to accommodate the annular flange, a circular seal having a diameter configured to fit within a hose aperture, and an O-ring configured to fit between the annular flange and a wall of the annular recess when the blocks are in a mated position.

### BACKGROUND

The ability to achieve a well-sealed coupling between lines in various systems, such as cooling or refrigeration systems in vehicles, is very important. A compromised or ineffective seal can reduce system efficiency, or prevent a system from functioning altogether. Further, it is desirable to prevent leaks of potentially toxic or environmentally hazardous materials. Unfortunately, present systems are susceptible to being compromised or failing upon variations of torque loads. Accordingly, there is a need for an improved sealing system to provide improved robustness with respect to loads such as torque loads.

### DRAWINGS

FIG. 1 is a side view of a sealing system including an exemplary seal fitting.

FIG. 2 is an exploded perspective view of the exemplary seal fitting of FIG. 1.

FIG. 3 is a side perspective view of an exemplary male block of the exemplary seal fitting of FIG. 1.

FIG. 4 is a side perspective view of an exemplary female block of the exemplary seal fitting of FIG. 1.

FIG. 5 is a cross-sectional view of a portion of the exemplary seal fitting of FIG. 1.

### DETAILED DESCRIPTION

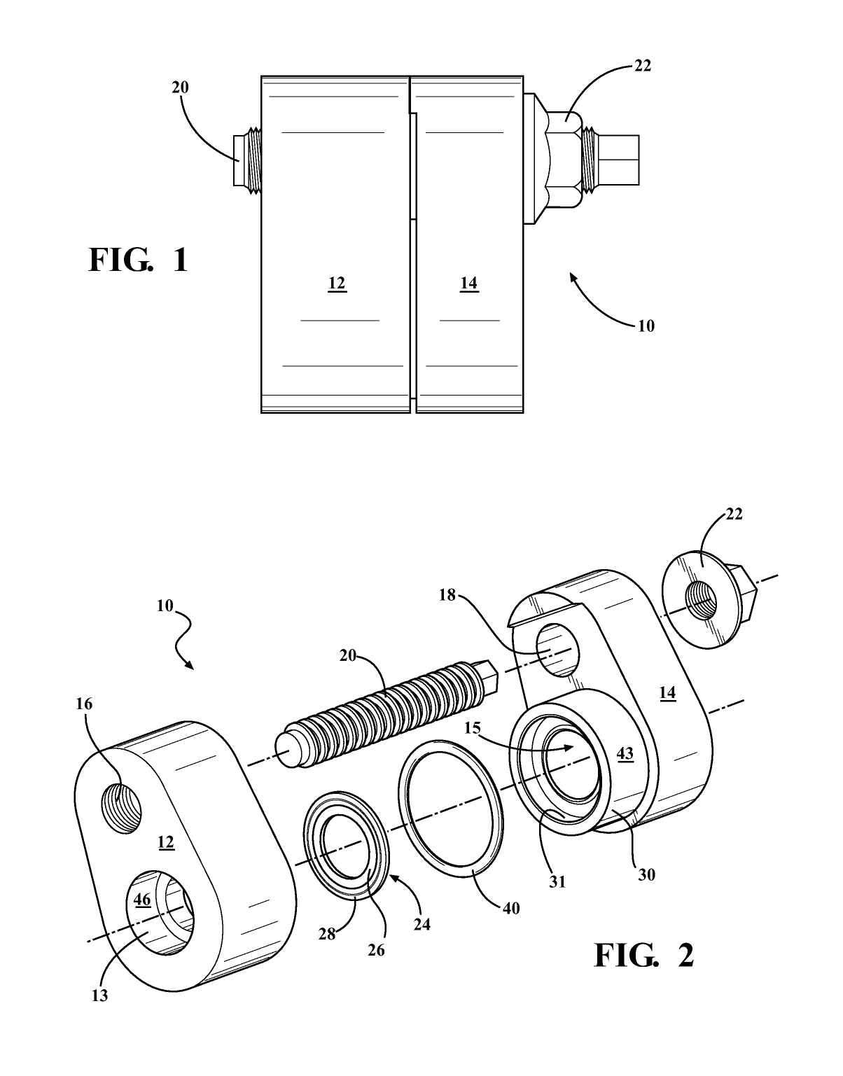

FIG. 1 is a side view of a sealing system including an exemplary seal fitting 10. The seal fitting 10 includes a female block 12 and a male block 14 that are configured to be mated to one another. For example, as best seen in FIG. 2, the seal fitting 10 may include a threaded stud 20 and a nut 22, the stud 20 being configured to be received in threaded apertures 16, 18, included respectively in the female block 12 and male block 14. The nut 22 may be tightened about the stud 20 to secure the blocks 12, 14 in a mated position, e.g., as seen in FIG. 1.

Further, as seen in FIGS. 2-4, the blocks 12, 14 respectively include hose apertures 13, 15, each configured to accommodate a hose 11, e.g., a hose for transporting a coolant such as R1234yf, R1234a, R744, or the like. The male block 14 further includes an annular flange 30, generally extending orthogonally from an inner wall 19 of the block 14, and extending circumferentially about the hose aperture 15. The inner wall 19 is generally planar, but may include a protrusion 47 at an end proximate to the threaded aperture 18. Further, the female block 12 includes an annular recess 32 extending inwardly from a generally planar inner wall 17 of the female block 12, the aperture 13 including an annular inner wall 46 in the female block 12. The annular recess 32 is configured to accommodate the annular flange 30, and the walls 17, 19 face each other in close proximity e.g., less than a millimeter, half a millimeter, one-tenth millimeter, etc., when the blocks 12, 14 are mated, except that the protrusion 47 of the wall 19 may contact the wall 17.

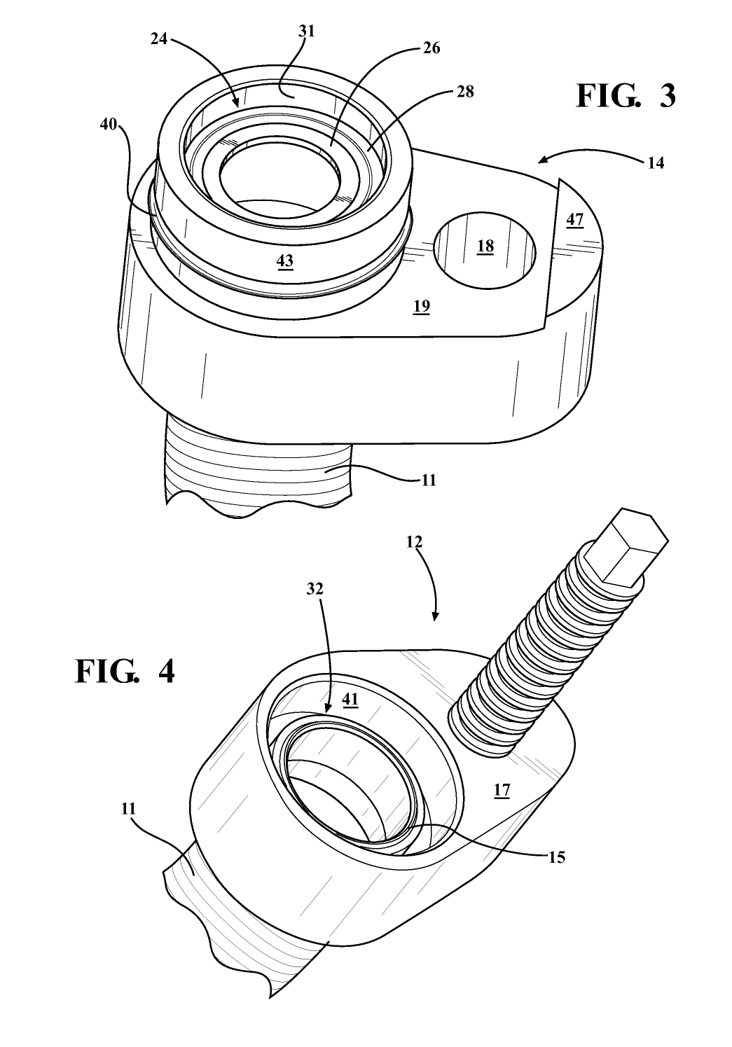

As seen in FIG. 3, a circular seal 24 may be situated within an interior circumferential wall 31 of the flange 30. The generally circular seal 24 generally includes an inner seal element 26 and an outer seal element 28. The inner seal element 26 may be metal, and the outer seal element 28 may be an elastomer. Further, an O-ring 40, made from an elastomer or the like, may be fixed and/or situated about an outer circumferential wall 43 of the flange 30.

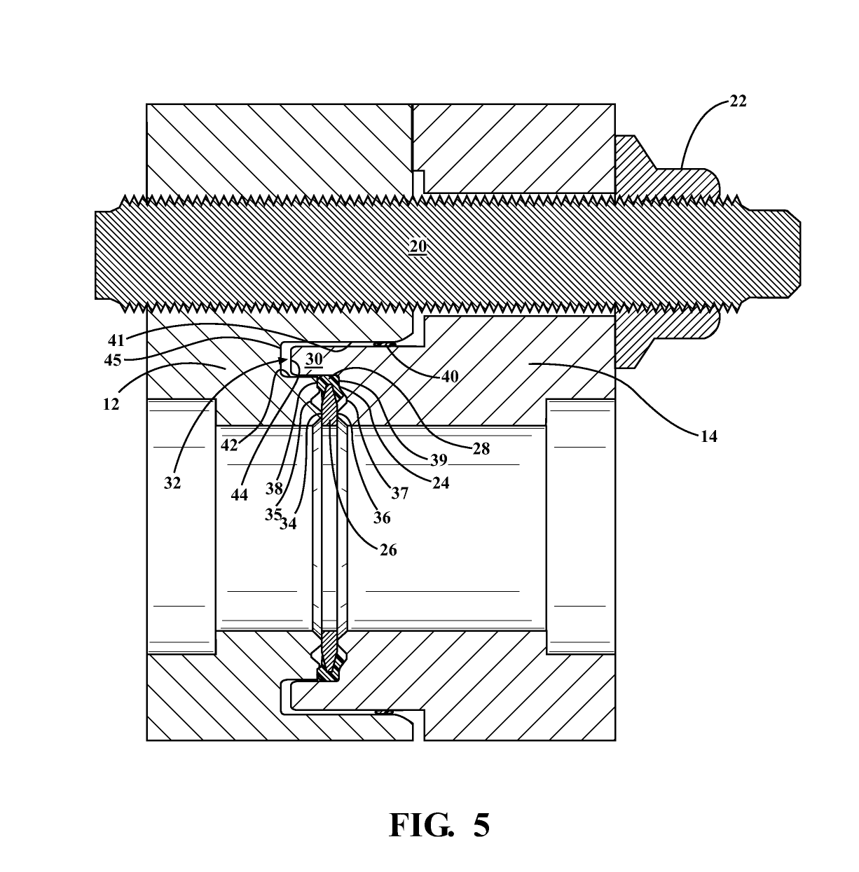

As seen in FIGS. 4 and 5, the female block 12 includes the annular recess 32 to accommodate the flange 30 of the male block 14 when the blocks 12, 14 are mated. Further, as seen in FIG. 5, when the blocks 12, 14 are mated, the O-ring 40 is situated between an exterior circumferential wall of the annular flange 30, and an inner wall 41 of the annular recess 32. Note that other locations of the O-ring 40 are possible, e.g., between the interior circumferential wall of the annular flange 30 and an inner wall 42 of the annular recess 32, or between an end wall 44 of the flange 30 and an end wall 45 of the recess 32. Accordingly, the O-ring 40 advantageously provides a sealing function, e.g., in addition to the seal 24, such that, e.g., under varying, heavy, and/or unexpected torque loads, the seal fitting 10 may maintain a seal desired in a system such as a cooling system even when the seal 24 does not prevent leaks and/or fails altogether.

FIG. 5 further illustrates placement of the seal 24 when the blocks 12, 14 are mated. The female block 12 may include a seal extension 34 that abuts the inner seal element 26, while a seal recess 35 accommodates insertion of the seal 24 including the outer seal element 28, which may abut a block seal wall 38. Similarly, the male block 14 includes a seal extension 36, a recess 37, and seal wall 39, which similarly accommodate a second side of the seal 24 including the respective elements 26 and 28.

Although a single block geometry including generally ovate blocks 12, 14, has been discussed herein with respect to the seal fitting system 10, it is to be understood that the O-ring 40 and other elements of the seal fitting system 10 could be implemented in other configurations such as a dual pilot block configuration, e.g., on a thermostatic expansion valve (TXV) connection. The seal system 10 is contemplated for use in vehicle, e.g., automotive, cooling systems or the like, but other applications are not outside the scope of the present disclosure and claims.

In the drawings, the same reference numbers indicate the same elements. Further, some or all of these elements could be changed. Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A sealing system, comprising:
a male block including an annular flange;
a female block including an annular recess configured to accommodate the annular flange;
a circular seal having a diameter configured to fit within a hose aperture; and
an O-ring configured to fit between the annular flange and a wall of the annular recess when the blocks are in a mated position.

2. The sealing system of claim 1, wherein the annular flange surrounds a first aperture and an annular inner wall of the female block defines a second aperture.

3. The sealing system of claim 4, wherein each of the first aperture and the second aperture are configured to accommodate a hose.

4. The sealing system of claim 1, further comprising a threaded stud and a nut, wherein the male block and the female block each include threaded apertures configured to accommodate the threaded stud, and further wherein the nut is configured to be tightened on the threaded stud to secure the male block and the female block in a mated position.

5. The sealing system of claim 1, wherein the O-ring is made from an elastomer.

6. The sealing system of claim 1, wherein the circular seal includes an inner metal sealing element and an outer elastomer sealing element.

7. The sealing system of claim 6, wherein the circular seal is configured so that the outer sealing element is within an inner circumferential wall of the annular flange when the blocks are in a mated position.

8. The sealing system of claim 1, configured such that the O-ring can be situated between an exterior circumferential wall of the annular flange and an inner wall of the annular recess when the blocks are mated.

9. The sealing system of claim 1, configured such that the O-ring can be situated between an interior circumferential wall of the annular flange and an inner wall of the annular recess when the blocks are mated.

10. The sealing system of claim 1, configured such that the O-ring can be situated between an end wall of the flange and an end wall of the recess when the blocks are mated.

11. The sealing system of claim 1, adapted for use in a vehicle cooling system.
